(19) United States
(12) Patent Application Publication
(10) Pub. No.: US 2021/0323482 A1
(43) Pub. Date: Oct. 21, 2021

(54) DEVICE FOR A MOTOR VEHICLE

(71) Applicant: Brose Fahrzeugteile SE & Co. Kommanditgesellschaft, Coburg, Coburg (DE)

(72) Inventors: Lucas BECKER, Berlin (DE); Nick GROSSKOPF, Berlin (DE)

(73) Assignee: Brose Fahrzeugteile SE & Co. Kommanditgesellschaft, Coburg, Coburg (DE)

(21) Appl. No.: 17/274,249

(22) PCT Filed: Sep. 2, 2019
(86) PCT No.: PCT/EP2019/073356

§ 371 Date: Apr. 27, 2021

(30) Foreign Application Priority Data
Sep. 12, 2018 (DE) 10 2018 215 537.2

(51) Int. Cl. B60R 7/04; B60N 2/68

(52) U.S. Cl. CPC B60R 7/043; B60N 2/68

(57) ABSTRACT

A device for a motor vehicle, defining a storage space for storing objects on a base surface of the storage space, the storage space is delimited by two opposing lateral parts and a distance between the two lateral parts is variable for changing the volume of the storage space. At least one portion of the base surface of the storage space is formed by a portion of at least one first flexible traction means.

### CROSS-REFERENCE TO RELATED APPLICATIONS

This application is the U.S. National Phase of PCT Application No. PCT/EP2019/073356 filed Sep. 2, 2019, which claims priority to German Patent Application No. DE 10 2018 215 537.2 filed Sep. 12, 2018, the disclosures of which are hereby incorporated in their entirety by reference herein.

### TECHNICAL FIELD

The present disclosure relates to a device for a motor vehicle.

### BACKGROUND

Trays and folding boxes vary in size and may be used in motor vehicles. As an example, the volume of the storage space can be variable.

The functionality of a folding box is limited due to the fact that an optimum storage of objects requires the lateral and base surfaces to be flat. In a mechanism in which the lateral surfaces or the base surface are pivotable relative to the storage space for varying the volume of the storage space, the lateral and base surfaces are not flat. Therefore, the quality of the provided functionality depends on the current fold-out width. In addition, several different types of movement kinematics for varying the size of the folding box can lead to the fact that the functionality of the folding box is limited in dependence on the fold-out width.

### SUMMARY

A proposed device provides that at least one portion of the base surface of the storage space is formed by a portion of at least one first flexible traction means, for example a belt or a textile strap. The portion of the at least one first flexible traction means for example may only partly form the base surface. As an example, only a portion of a plane between lateral parts, in which the base surface is arranged, is formed by the portion of the at least one first flexible traction means. The base surface and the lateral parts cooperate in order to provide the storage space for storing objects. The portion of the at least one first traction means may extend when the volume of the storage space is increased and can be retracted when the volume of the storage space is reduced. Thus, the base surface can be flexibly adaptable to the distance between the lateral parts. Due to the flexible adaptation of the base surface to the distance, the size of the device may vary and the functionality may remain the same. For example, the device may provide a cuboid-shaped storage space independently of the volume. Moreover, objects stored already can be fixable in the device by reducing the volume.

In one or more embodiments, the device may be used in a driver's seat, the device can provide a safe storage for portable objects belonging to the vehicle occupant or driver. In the device, objects can conveniently be storable within reach of the occupant, such as on the vehicle seat on which the occupant sits as intended. In the case of an acceleration of the motor vehicle, such as a cornering maneuver, braking, starting, rolling over or in a collision, the objects can be securely stored in the device, for example by clamping.

The lateral parts can be arranged mirror-symmetrically to each other in relation to a plane in the middle between the lateral parts. The lateral parts optionally can be arranged parallel to each other. For changing the volume of the storage space, the lateral parts can be adjustable along an axis that is extended perpendicularly to the two lateral parts. For a change in volume, one of the lateral parts can be adjustable relative to the other lateral part. In one or more embodiments, for a change in volume the lateral parts can be adjustable relative to a plane in the middle between the lateral parts.

In one exemplary embodiment, the at least one first traction means is stretched between the lateral parts. The at least one first traction means hence connects the lateral parts. In one embodiment, the base surface is formed of strip-shaped portions of a plurality of first traction means. The plurality of first traction means here can be extended parallel to each other. In principle, the at least one first traction means can be extended at any angle to the lateral parts. For example, the at least one first traction means can be configured to form an oblique base surface that is positioned at an oblique angle to the lateral parts. Objects stored in the device can then be movable along the base surface to the lowest point due to earth gravity.

In one alternative embodiment, the at least one first traction means may be stretched perpendicularly to the lateral parts. The lateral parts and the at least one first traction means can then together form a U-shaped storage space.

The at least one first traction means can be fixed to only one of the two lateral parts. In particular, the at least one first traction means can pretension one of the two lateral parts against a vehicle seat. In one exemplary embodiment, the at least one first traction means at one end is fixed to the first lateral part. The first lateral part can be adjustable relative to the second lateral part. The at least one first traction means can be connected to the first lateral part or be braced or clamped to the first lateral part. At the opposite end, the at least one first traction means can be fixed to an associated winding element, for example a winding reel, such as a belt winding reel, at the second lateral part. On the associated winding element, a fastening element can be provided for fixing the at least one first traction means. The associated winding element can be configured to wind and unwind the at least one first traction means. Hence, as an example, a portion of the at least one first traction means can form a portion of the base surface, and another portion of the at least one first traction means can be wound up on the associated winding element.

A portion of the at least one first traction means between the base surface and the associated winding element can be extended over a guide element on the second lateral part. By means of the guide element, an introduction of the at least one first traction means from the associated winding element into the area between the lateral parts is possible. Proceeding from the associated winding element, the at least one first traction means can pass through the second lateral part through a passage point. From the passage point, the at least one traction means can be extended to a contact point on the first lateral part, at which the at least one first traction means touches the first lateral part. Proceeding from the first lateral part, the at least one first traction means hence can be extended to the winding element perpendicularly to the lateral parts over a guide element on the second lateral part.

The passage point of the at least one first traction means through the second lateral part can be mirror-symmetrical to the contact point. The mirror symmetry here can be related to a plane in the middle between the lateral parts. Particularly in the case of an associated winding element whose radius varies, it can be ensured by means of the guide element that the passage point is mirror-symmetrically opposite the contact point.

In one exemplary embodiment, a length of a portion of the at least one first traction means, which is wound up during a revolution of 360° of the associated winding element with a radius R, is equal to a circumference 2πR. The associated winding element hence is circular in this exemplary embodiment. A uniform rotation of the associated winding element about the center of the circle leads to the at least one first traction means being uniformly unwound or wound up. The term “uniformly” here can refer to the fact that the speed of the process, for instance a movement, a rotation, an adjustment or winding up or unwinding, is effected at a constant velocity or angular velocity. A phase of positive acceleration initial for the process or a phase of negative acceleration terminating the process are conceivable and possible. In principle, the time intervals of the phases can be a fraction, for example 1/10 or 1/100, of the time of the entire process. A non-uniform rotation of the associated winding element leads to the at least one first traction means being non-uniformly unwound or wound up. The term “non-uniformly” here can refer to the fact that the speed of the process is effected at a decreasing or increasing velocity or angular velocity, i.e. a negative or positive acceleration.

In an alternative exemplary embodiment, the associated winding element is not circular or circular and eccentrically mounted. In such a winding element, a uniform rotation can lead to the at least one first traction means being unwound or wound up non-uniformly.

One reason may be that a portion of a circumference of the associated winding element, over which the at least one first traction means is extended, is dependent on the position of the portion on the circumference. Based on an angular interval, a length of a portion of the at least one first traction means wound up on the associated winding element hence can vary in dependence on the direction of the angular interval proceeding from a point on the winding element. The angular interval can be a fraction of 360°, such as 5°, 10° or 170°.

A portion of the at least one first traction means wound up on or unwound from the associated winding element during a rotation about the angular interval hence can be longer or shorter than a portion that has been wound up or unwound with a rotation about the angular interval before or after. In particular, a uniform rotary movement of the associated winding element thus can be convertible into a non-uniform unwinding or winding up of the at least one first traction means.

A winding element that is suitable to convert a uniform rotary movement into a non-uniform unwinding or winding up of the at least one first traction means is mounted eccentrically, for example. Additionally or optionally, the winding element can be configured elliptical, substantially as a logarithmic spiral or in the form of a snail shell. In principle, the radius of the associated winding element can realize any function of an azimuth angle that indicates a position on the circumference or the edge of the associated winding element.

In another exemplary embodiment, the two lateral parts are connected to each other via at least one arm. By means of the at least one arm, the distance between the lateral parts can be adjustable. The at least one arm can be of rigid design, for example, so that the distance can be varied by means of a swivel movement of the at least one arm relative to one of the lateral parts. The at least one arm in particular can form a coupling gear for adjusting the lateral parts relative to each other. Likewise, the at least one arm can comprise at least one folding or hinged joint so that the distance can be varied by folding the at least one arm in or out. The at least one arm can also be telescopic in design so that the distance can be varied by telescopically retracting or extending the at least one arm.

In one embodiment, the lateral parts each comprise a side wall, which side walls form a flat boundary of the storage space, and two frame elements each, which delimit the side walls perpendicularly to the base surface and form edges of the storage space. The ends of the at least one arm can be arranged for example on a side wall or on the frame elements. In one variant, the at least one arm is extended from a side wall of a lateral part to a frame element of the other lateral part. In principle, the ends of the at least one arm can be arranged on the lateral parts at any point.

In another alternative embodiment, the at least one arm is arranged on a side of the lateral parts adjacent to the base surface. For example, the at least one arm can be extended parallel to the base surface. The at least one arm hence can connect to sides of the lateral part on the side of the base surface. The at least one arm likewise can connect two sides of the lateral parts, which are extended perpendicularly to the base surface. In principle, the at least one arm likewise can be extended between two sides of the lateral parts, which face each other along the lateral parts of the base surface. In particular, the objects here can be storable in the storage space via an axis parallel to the base surface.

A length of the at least one arm can correspond to the distance of the lateral parts in a maximum position. In the maximum position of the device, the volume of the storage space can be maximal. A height of the lateral parts above the base surface can correspond to the distance of the lateral parts in the maximum position. A side of the storage space on the side of the at least one arm hence can be of square shape.

In one exemplary embodiment, the device comprises at least two arms. The at least two arms can be arranged on a side of the storage space. In the maximum position of the device, the at least two arms can be extended parallel to each other. The at least two arms can be arranged perpendicularly to the lateral parts. In the stowage position of the device, in which the volume of the storage space is minimal, the at least two arms can be crossed. When the at least two arms are crossed, they can intersect. Hence, there can be a crossing point. At the crossing point, the at least two arms can intersect like scissors or in an X-shaped manner. In the stowage position, the at least two arms in principle can be arranged (almost) parallel to the lateral parts.

In another exemplary embodiment, two pairs of arms are arranged symmetrically to each other on sides of the lateral parts facing each other along the base surface. One pair of arms each can be arranged on a side of the lateral parts to which the base surface adjoins. The respectively other pair can be symmetrically arranged on the opposite side of the lateral parts, in relation to a plane that is extended perpendicularly through the middle of the lateral parts. In particular, in the maximum position the pairs of arms can be arranged parallel to each other. In the maximum position, the pairs of arms can form edges of the storage space parallel to the base surface. In the stowage position, the pairs of arms can each be crossed. In a design position between the maximum position and the stowage position, the pairs of arms or the at least one arm can form a portion of a lateral surface of the storage space.

In an exemplary embodiment, the at least one arm is pivotally articulated to the first lateral part at one end. For example, the at least one arm with one end can be articulated to the side wall of the first lateral part or to a frame element of the first lateral part. The at least one arm can be articulated to the first lateral part at an associated joint. The associated joint can be arranged for example on a side of the first lateral part that faces the second lateral part. Likewise, the associated joint can be arranged on a side of the first lateral part that is extended perpendicularly to the second lateral part. The side of the first lateral part, on which the associated joint is arranged, can be arranged on an inside of the second lateral part or on an outside of the second lateral part.

With the other end, the at least one arm can be shiftably mounted on the second lateral part. For example, with the other end the at least one arm can be shiftably mounted on the side wall of the second lateral part or on a frame element of the second lateral part. The at least one arm can be pivotally mounted on the second lateral part on an associated driver, in particular a slider. The associated driver can be shiftable along the second lateral part. The pivotal mounting to the associated driver hence provides for a shifting movement of the other end of the at least one arm and at the same time for pivoting of the at least one arm relative to the driver. The associated driver can be arranged for example on a side of the second lateral part that faces the first lateral part. Likewise, the associated driver can be arranged on a side of the second lateral part that is extended perpendicularly to the first lateral part. The side of the second lateral part, on which the associated driver is arranged, can be arranged on an inside of the second lateral part or on an outside of the second lateral part.

A displacement of the associated driver can cause the one end of the at least one arm to pivot on the first lateral part. As an example, the adjustment of the at least one arm relative to the lateral parts can cause a reduction of the length of the projection of the at least one arm onto the base surface. The adjustment of the at least one arm hence can cause a variation of the distance between the lateral parts. Via the adjustment of the at least one arm, an adjusting force hence can be transmittable from one of the lateral parts to the other lateral part, which causes the distance between the lateral parts to be changed. As an example, via the at least one arm a horizontal closing force or opening force can be transmittable from the second lateral part to the first lateral part.

A displacement of the other end of the at least one arm towards a position in which the at least one arm is arranged perpendicularly to the lateral parts here can lead to an increase of the distance of the lateral parts. A displacement of the other end of the at least one arm away from a position in which the at least one arm is arranged perpendicularly to the lateral parts can lead to a decrease of the distance of the lateral parts. The variation of the distance of the lateral parts hence can be dependent on the direction of displacement of an end of the at least one arm along one of the lateral parts.

In one embodiment, the associated driver is shiftable on the second lateral part by means of a cable, as an example a Bowden cable. To this end, the cable can engage the associated driver by means of a second traction means. The associated driver can be guided on the second lateral part along an associated guide. The associated guide can be extended perpendicularly to the base surface. The associated guide can be arranged for example on a side of the second lateral part that faces the first lateral part. Likewise, the associated guide can be arranged on a side of the second lateral part that is extended perpendicularly to the first lateral part. The side of the second lateral part, on which the associated guide is arranged, can be arranged on an inside of the second lateral part or on an outside of the second lateral part. For example, the associated guide can be formed on the side wall of the second lateral part or on a frame element of the second lateral part. The second traction means likewise can at least sectionally be extended along the associated guide.

As an example, two associated guides can be formed on at least one frame element of the second lateral part. The two associated guides can jointly be formed on a side of the at least one frame element that faces the first lateral part. The two associated guides can likewise be formed on two opposite sides of the at least one frame element, which are formed perpendicularly to the lateral parts. One of the sides can be an inside of the second lateral part, and the other side can be an outside of the second lateral part. In principle, the at least one frame element can laterally delimit the second lateral part, such as a side wall of the second lateral part, perpendicularly to the base surface.

The radius of the associated winding element can be formed incrementally in dependence on the azimuth angle at the associated winding element:

The distance L between the lateral parts can be a function of the arm angle α_{A}, the angle of the at least one arm relative to one of the lateral parts. Then, a difference ΔL between two distances L with associated arm angles α_{A1}, α_{A2} can be given by: ΔL=S (sin(α_{A2}) sin(α_{A1})), wherein S is the length of the at least one (rigid) arm. When it is desired that for adjusting the device from the stowage position into the maximum position and vice versa, the associated winding element rotates about an azimuth angle α_{w} of 360°, the following can apply: 4α_{A}=α_{w}. Basically, any relation between the azimuth angle and the arm angle is conceivable and possibly. Hence, it can apply: ΔL=S (sin(¼ α_{w2}) sin(¼ α_{w1})).

For adjusting the device from the stowage position into the maximum position and vice versa, a portion of the at least one first traction means can be wound up or unwound with a length that corresponds to the maximum distance Lₘₐₓ between the lateral parts or a length S of the at least one arm. A circumferential length L_{U} of the associated winding element L_{U}=2πR then should correspond to Lₘₐₓ or S.

A difference between two azimuth angles Δα_{w}=α_{w2}−α_{w1}, about which the associated winding element is rotated, consequently can be converted into a length wound up or unwound of at least one first traction means in the amount of ΔL_{U}=2πR Δα_{w}/360°. When it is desired that the length of the portion of the at least one first traction means, which forms a portion of the base surface, is varied synchronously with the distance of the lateral parts, the following can apply: ΔL_{U}=ΔL. Hence it follows that: R(α_{w1}, α_{w2})=Lₘₐₓ [sin(¼ α_{w2}) sin(¼ α_{w1})]/[α_{w2}−α_{w1}]. By replacing α_{w2}=Δα_{w}+α_{w1}, the following can apply for the radius of the associated winding element in dependence on the azimuth angle:

$$R ( {α}_{W} ) = {L}_{max} \times \frac{sin ( C ( {α}_{W} + {Δα}_{W} ) ) - sin ( C \times {α}_{W} )}{{Δα}_{W}}$$

C can adopt the value ¼, when 4α_{A}=α_{w} applies. As mentioned above, C can be chosen arbitrarily in principle for the relation between the azimuth angle and the arm angle. The radius can be calculable numerically. As an example, the radius can be calculable incrementally via the difference between two azimuth angles.

In an exemplary embodiment, the associated winding element is configured to perform at least one rotation about an axis of rotation for winding up or unwinding the at least one first traction means. In principle, the associated winding element also can perform less or more than one rotation about the axis of rotation in order to adapt the base surface to an adjustment of the device from the maximum position into the stowage position and vice versa. A size of the associated winding element can be smaller the more revolutions are required in order to adjust the device from the maximum position into the stowage position. This can save installation space on the device.

R(α_{w}) for example can be a periodic function. As an example, periodically recurring patterns in the speed or acceleration of the adjusting movement of the lateral parts thus can be depicted on the associated winding element by means of R(α_{w}). The shape of the associated winding element hence can depict a (periodic) adjusting movement of the lateral parts relative to each other.

In an exemplary embodiment, a drive is provided on the device for introducing an adjusting force into the Bowden cable and for applying a driving force onto the associated winding element. By means of the drive, the Bowden cable and the associated winding element can be actuatable synchronously. As an example, the length of the base surface and the distance between the two lateral parts can be adjustable by the common drive synchronously with each other.

The drive can engage the second traction means in order to introduce an adjusting force into the Bowden cable. At the same time, the drive can engage the associated winding element in order to introduce a driving force into the associated winding element. The drive hence can be configured to rotate the associated winding element and actuate the Bowden cable at the same time. The drive hence can actuate a first movement kinematic for adjusting the base surface and a second movement kinematic for changing the distance of the lateral parts.

In one embodiment, the drive engages the associated winding element via a physically formed axis of rotation of the associated winding element. The axis of rotation can comprise for example a pinion, such as a belt wheel, which is engaged by the drive. On the drive, there can be provided an input-side pinion, such as an input-side belt wheel, which is connected to the pinion on the axis of rotation by means of a third traction means, for example a belt.

In an alternative embodiment, the drive transmits a driving force to the associated winding element by means of a transmission mechanism. The transmission mechanism can comprise the input-side pinion, the third traction means and/or the pinion on the axis of rotation. Alternatively or additionally, the transmission mechanism can comprise an, for example eccentric, spur-gear transmission. An eccentric spur-gear transmission serves to convert a uniform input-side rotation into a non-uniform output-side rotation. By means of the transmission mechanism, a uniform movement of the drive hence can be convertible into a non-uniform movement of the associated winding element.

Hence, the first movement kinematic in principle can generate a uniform movement. By means of a transmission mechanism and/or an associated winding element, such as with a variable radius, the first movement kinematic can convert a uniform movement into a non-uniform movement. The second movement kinematic can generate a non-uniform movement for example by means of a coupling gear with the at least one arm. The first movement kinematic can generate a non-uniform movement that is synchronous with the non-uniform movement of the second movement kinematic. For this purpose, the variable radius can be oriented towards the (extension distance) function of the coupling gear. The proposed solution hence allows to couple a uniform movement of the associated winding element with a non-uniform movement, in order to use e.g. a common drive.

The described device is suitable for use in a motor vehicle. For example, the device can serve as a tray on a vehicle seat or in a trunk.

### BRIEF DESCRIPTION OF THE DRAWINGS

The attached Figures by way of example illustrate possible design variants of the proposed solution.

In the drawings:

FIG. 1A shows a perspective view of a device for a motor vehicle, arranged on a vehicle seat in the maximum position;

FIG. 1B shows a perspective view of a device for a motor vehicle, arranged on a vehicle seat in the stowage position;

FIG. 2A shows a side view of a device for a motor vehicle in the maximum position;

FIG. 2B shows a side view of a device for a motor vehicle in the stowage position;

FIG. 3A shows a rear view of a device for a motor vehicle in the maximum position;

FIG. 3B shows a rear view of a device for a motor vehicle in the stowage position;

FIG. 4 shows a side view of a device for a motor vehicle comprising three winding elements and three first traction means;

FIG. 5 shows the course of a second traction means of the device for a motor vehicle;

FIG. 6 shows a front view of a second lateral part of a device for a motor vehicle comprising a third traction means;

FIG. 7A shows a schematic view of a device for a motor vehicle in a stowage position;

FIG. 7B shows a schematic view of a device for a motor vehicle between a stowage position and a maximum position;

FIG. 7C shows a schematic view of a device for a motor vehicle between a stowage position and a maximum position;

FIG. 7D shows a schematic view of a device for a motor vehicle in a maximum position;

FIG. 8A shows a representation of a dependence of the radius of a winding element on an angle in Cartesian coordinates; and

FIG. 8B shows a representation of a dependence of the radius of a winding element on an angle in polar coordinates.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

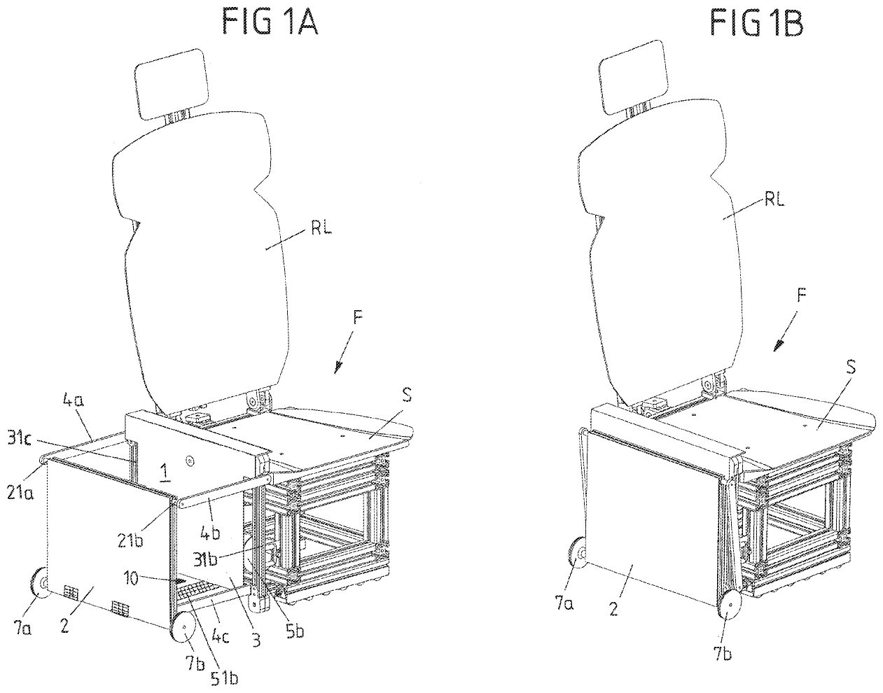

FIG. 1A shows of a device for a motor vehicle, which is arranged on a vehicle seat F. The vehicle seat F comprises a seat part S for properly sitting on the vehicle seat F and a backrest RL. The device is configured for arrangement on the seat part S. The device here is laterally arranged on the seat part S so that a user of the device properly sitting on the vehicle seat F can store objects in the device to the left or right of himself. In principle, the device can of course be arranged on any side of the vehicle seat F and for example of the seat part S, such as behind the user, or at another place in the motor vehicle.

The device comprises a storage space 1 for storing objects on a base surface 10 of the storage space 1. The storage of objects is effected along the earth gravity. The base surface 10 is arranged perpendicularly to the earth gravity. However, the base surface 10 can also be arranged parallel to the earth gravity or at any other angle thereto. For example, the device can be utilized for storing objects in a trunk of the motor vehicle. The base surface 10 then can form a delimitation of the storage space 1 parallel to the earth gravity.

The storage space 1 is delimited by two opposing lateral parts 2, 3 whose distance L is variable for changing the volume of the storage space 1. For delimiting the storage space 1, the two lateral parts 2, 3 each comprise a side wall 24, 34. The two lateral parts 2, 3, such as the side walls 24, 34, are arranged parallel to each other. The storage space 1 thereby is of substantially cuboid design. In principle, the lateral parts 2, 3 can be arranged at an angle, such as in a wedge-shaped manner, or in any alignment to each other. Furthermore, the side walls 24, 34 are of flat design. As a result, the objects can be clamped between the side walls 24, 34 at any height and at any point of the storage space 1. Of course, bulges or moldings of any shape can be provided at the side walls 24, 34. On the lateral parts 2, 3 and in the interior of the storage space 1 further components, such as for example a suspension device, like a hook, or stopping elements for example for abutment against the opposing lateral part 2, 3, can likewise be arranged.

FIG. 1A shows a maximum position of the device, in which the volume of the storage space 1 is maximal. FIG. 1A shows a stowage position of the device, in which the volume of the storage space 1 is minimal. The volume of the storage space 1 is variable between the maximum position and the stowage position. For varying the volume, the distance L between the lateral parts 2, 3 is variable. On the first lateral part 2, wheels 7a, 7b are laterally arranged. The wheels 7a, 7b support the device on the side of the device spaced apart from the vehicle seat F. In principle, the first lateral part 2 likewise can be supportable by means of rails or another supporting device on the side of the device spaced apart from the vehicle seat F. It is also conceivable and possible that the first lateral part 2 is not supported along the earth gravity. The first lateral part 2 can be held for example by the arms 4a, 4b, 4c, 4d.

A (visible) portion of the base surface 10 of the storage space 1 is formed by portions of two first flexible traction means 51a, 51b. Hence, objects can be stored in the storage space 1 on the portions of the first traction means 51a, 51b. Independently of the position of the device, the base surface 10 is formed by the first traction means 51a, 51b. The first traction means 51a, 51b therefor are stretched between the two lateral parts 2, 3 perpendicularly to the lateral parts 2, 3. The first traction means 51a, 51b are extended parallel to each other. In a plane of the base surface 10, they form a strip-shaped pattern of alternating blanks at which no base surface 10 is present and of portions of the first traction means 51a, 51b which form portions of the base surface 10. In principle, the first traction means 51a, 51b can have any alignment along the base surface 10 or to each other.

The two first traction means 51a, 51b are fixed to the first lateral part 2 at one of their two ends. For example, the two first traction means 51a, 51b can be clamped, adhesively bonded or braced with the first lateral part 2. At the other one of their ends, the two first traction means 51a, 51b are fixed to an associated winding element 5a, 5b on the second lateral part 3. In principle, the two first traction means 51a, 51b likewise can be extended from an associated winding element 5a, 5b on the first lateral part 2 to the second lateral part 3.

Each of the two first traction means 51a, 51b can be wound up on the associated winding element 5a, 5b. By means of the two winding elements 5a, 5b, the two first traction means 51a, 51b are stretched between the two lateral parts 2, 3. Winding up the two first traction means 51a, 51b on the associated winding element 5a, 5b, 5c generates a pull on the first lateral part 2. Due to the pull, the two first traction means 51a, 51b are tensioned. The two first traction means 51a, 51b hence can be usable for transmitting a tensile force to the first lateral part 2. In principle, it is also conceivable and possible that the first lateral part 2 is adjustable towards the second lateral part 3 by means of the first traction means 51a, 51b.

The two lateral parts 2, 3 are connected to each other via four arms 4a, 4b, 4c, 4d. The four arms 4a, 4b, 4c, 4d are adjustable for varying the distance L between the two lateral parts 2, 3. The ends of two arms 4a, 4b, 4c, 4d each are arranged on a common side of a lateral part 2, 3. Two arms 4a, 4b, 4c, 4d each connect various, opposing sides of the lateral parts 2, 3 to each other. The arms 4a, 4b, 4c, 4d hence are arranged in pairs on the lateral parts 2, 3. A pair of arms 4a, 4b, 4c, 4d is arranged symmetrically to a perpendicular bisector on the lateral parts 2, 3 and extended parallel to the base surface 10. In principle, the arms 4a, 4b, 4c, 4d can engage at any point of the lateral parts 2, 3. In the illustrated embodiment, one pair of arms 4a, 4b, 4c, 4d each is arranged in a plane that is extended perpendicularly to the base surface 10. In principle, the arms 4a, 4b, 4c, 4d can connect the two lateral parts 2, 3 to each other also in a plane parallel to the base surface 10 or in any other plane.

The two planes of the two pairs of arms 4a, 4b, 4c, 4d laterally delimit the storage space 1 together with the two opposing lateral parts 2, 3. The two first traction means 51a, 51b additionally delimit the storage space 1 as a base surface 10. The storage space 1 is accessible via an opening opposite the base surface 10 for storing objects. The size of the opening is variable via the distance L between the two lateral parts 2, 3.

For varying the distance L between the lateral parts 2, 3, the arms 4a, 4b, 4c, 4d are adjustable between an alignment perpendicular to the lateral parts 2, 3 into an alignment almost parallel to the lateral parts 2, 3. Two arms 4a, 4b, 4c, 4d each of each pair of arms 4a, 4b, 4c, 4d on each side of the lateral parts 2, 3 are arranged parallel to each other independently of the distance L between the lateral parts 2, 3. In the maximum position, the arms 4a, 4b, 4c, 4d are extended perpendicularly to the lateral parts 2, 3 and parallel to the base surface 10.

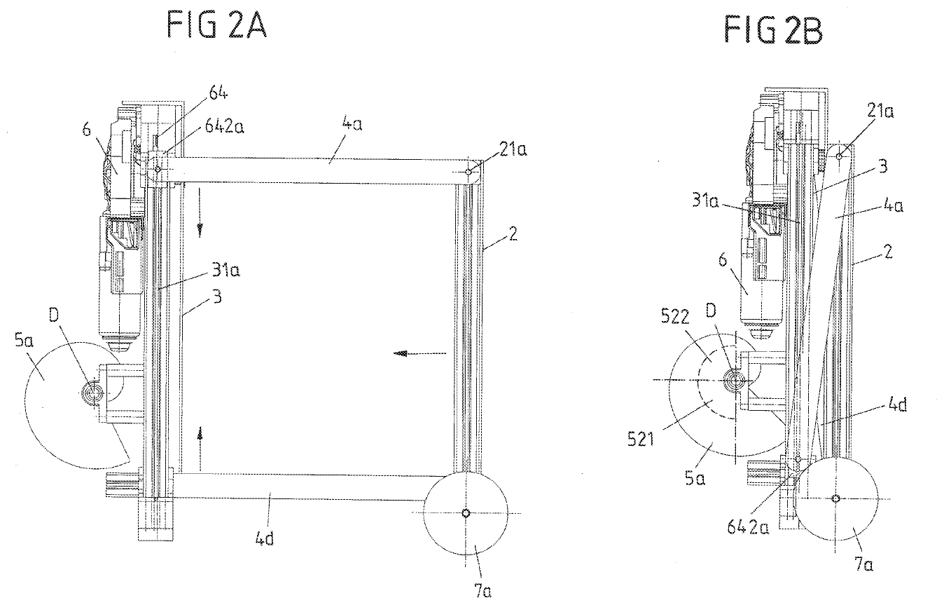

FIG. 2A shows the device in the maximum position from a lateral perspective. In the maximum position, the arms 4a, 4d in conjunction with the lateral parts 2, 3 form a rectangle. In the stowage position, which is shown in FIG. 2B, the arms 4a, 4d are crossed. In the stowage position, the arms 4a, 4d in conjunction with the lateral parts 2, 3 hence form an hourglass-shaped arrangement.

In principle, the arms 4a, 4b, 4c, 4d are of rigid design to transmit an adjusting force to the first lateral part 2. However, the arms 4a, 4b, 4c, 4d likewise can be of telescopic, spring-like or flexible design.

The arms 4a, 4b, 4c, 4d are pivotally articulated to the first lateral part 2 at one end. A movement of the end of the arms 4a, 4b, 4c, 4d along the first lateral part 2 is not provided in the illustrated embodiment. The ends of the arms 4a, 4d of a pair of arms 4a, 4d, which is arranged on one side of the lateral parts 2, 3, are articulated to the first lateral part 2, 3 at joints 21a spaced apart from each other perpendicularly to the base surface 10. One of the arms 4d is articulated to a joint (not shown) near the base surface 10 and another one of the arms 4a is arranged at a joint 21a that is spaced apart from the base surface 10 by the height of the first lateral part 2.

The joints near the base surface 10 each are arranged on a frame element 22a, 22b on an inside of the first lateral part 2 facing the storage space 1. The joints 21a, 21b of the arms 4a, 4b spaced apart from the base surface 10 each are arranged on the frame element 22a, 22b on an outside of the lateral parts 2, 3 facing away from the storage space 1. Due to the arrangement of the joints 21a, 21b, the ends of the arms 4a, 4b, 4c, 4d on the first lateral part 2 are space apart from each other over the height and width of the first lateral part 2. In principle, the ends of the arms 4a, 4b, 4c, 4d can be articulated at any point of the first lateral part 2. The arms 4a, 4b, 4c, 4d likewise can be shiftably mounted along the first lateral part 2.

At the other end, the arms 4a, 4b, 4c, 4d are shiftably mounted along the second lateral part 3. For guiding the arms 4a, 4b, 4c, 4d on the second lateral part 3, guides 31a, 31b, 31c, 31d are provided, along which the ends of the arms 4a, 4b, 4c, 4d are shiftable. For coupling the arms 4a, 4b, 4c, 4d with the second lateral part 3, one driver 642a, 642b, 642c, 642d each is provided. Via the drivers 642a, 642b, 642c, 642d the other end of the arms 4a, 4b, 4c, 4d hence is each shiftable along the second lateral part 3. The other end is pivotally articulated to the drivers 642a, 642b, 642c, 642d.

By means of the drivers 642a, 642b, 642c, 642d the arms 4a, 4b, 4c, 4d can be transferred from a position almost perpendicular to the base surface 10 into a position in which the arms 4a, 4b, 4c, 4d are arranged substantially parallel to the lateral parts 2, 3. The adjustment direction of the drivers 642a, 642b, 642c, 642d and of the first lateral part 2 for a reduction of the storage space 1 is designated by arrows in FIG. 2A.

According to the arrows, the end of the arm 4a spaced apart from the base surface 10, which is shiftably mounted on the second lateral part 3, is shiftable towards the base surface 10 for an adjustment from the maximum position into the stowage position. The end of the arm 4d shiftably mounted on the second lateral part 3, which is arranged closer to the base surface 10 than the other arm 4a, is shiftable away from the base surface 10.

The displacement of the ends of the arms 4a, 4b, 4c, 4d on the second lateral part 3 is convertible into an adjustment of the first lateral part 2. An adjusting movement of the ends of the arms 4a, 4b, 4c, 4d at a constant speed in a direction along the second lateral part 3 leads to a positively or negatively accelerated movement of the first lateral part 2 in order to increase or reduce the volume of the storage space 1.

The drivers 642a, 642b, 642c, 642d are shiftable along the second lateral part 3 by means of a Bowden cable 64. The Bowden cable 64 comprises a second flexible traction means 641 that engages the drivers 642a, 642b, 642c, 642d in order to effect a displacement. On the second lateral part 3, the drivers 642a, 642b, 642c, 642d each are guided on an associated guide 31a, 31b, 31c, 31d. As an example, the guides 31a, 31b, 31c, 31d can be extended in any direction and at any point along the second lateral part 3.

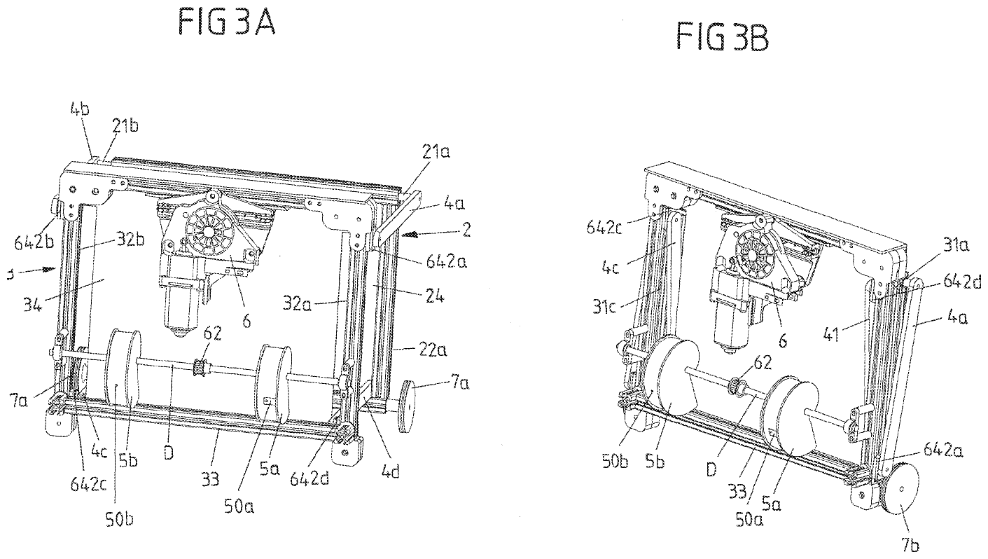

As shown in FIGS. 3A and 3B, the second lateral part 3 comprises two frame elements 32a, 32b on which the guides 31a, 31b, 31c, 31d are formed. The frame elements 32a, 32b form a lateral frame on the second lateral part 3. The frame elements 32a, 32b delimit the second lateral part 3 on opposite sides. On sides of the second lateral part 3, which adjoin the base surface 10, the frame elements 32a, 32b are extended perpendicularly to the base surface 10. On the side of the base surface 10, the frame elements 32a, 32b are connected to each other via a guide element 33. The guide element 33 serves to guide the two first traction means 51a, 51b between the associated winding elements 5a, 5b and the storage space 1. As an example, the guide element 33, together with the frame elements 32a, 32b form edges of the storage space.

One frame element 32a, 32b each forms guides 31a, 31b, 31c, 31d for one driver 642a, 642b, 642c, 642d each on two opposite sides. The two sides face each other in a plane of the second lateral part 3. One of the sides is arranged on the side of the storage space 1, the other side is arranged on the side of the frame element 32a, 32b facing away from the storage space. In principle, the ends of the arms 4a, 4b, 4c, 4d can also be shiftable along the second lateral part 3 on a side of the second lateral part 3 facing the first lateral part 2, for example on the second side wall 34.

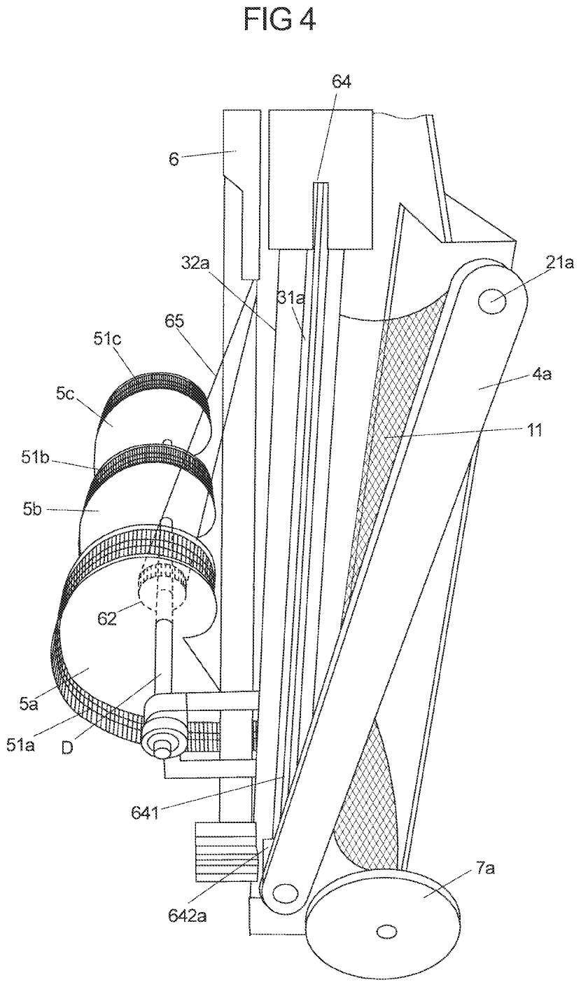

The end of the arms 4a, 4b, 4c, 4d arranged on the second lateral part 3 each is shiftable along the second lateral part 3 by means of a drive 6. The drive 6 is configured to actuate the Bowden cable 64. Via the Bowden cable 64, the drive 6 hence adjusts the end of the arms 4a, 4b, 4c, 4d arranged on the second lateral part 3. The drive 6 therefor engages the drivers 642a, 642b, 642c, 642d via the second traction means 641, as is shown in FIG. 4. The drive 6 is arranged on the second lateral part 3. In principle, the drive 6 can also be arranged on the first lateral part 2. As an example, the winding elements 5a, 5b, 5c and/or the Bowden cable 64 can be arranged on the first lateral part 2. The arms 4a, 4b, 4c, 4d can also be shiftably mounted along the first lateral part 2 and be pivotally mounted on the second lateral part 3.

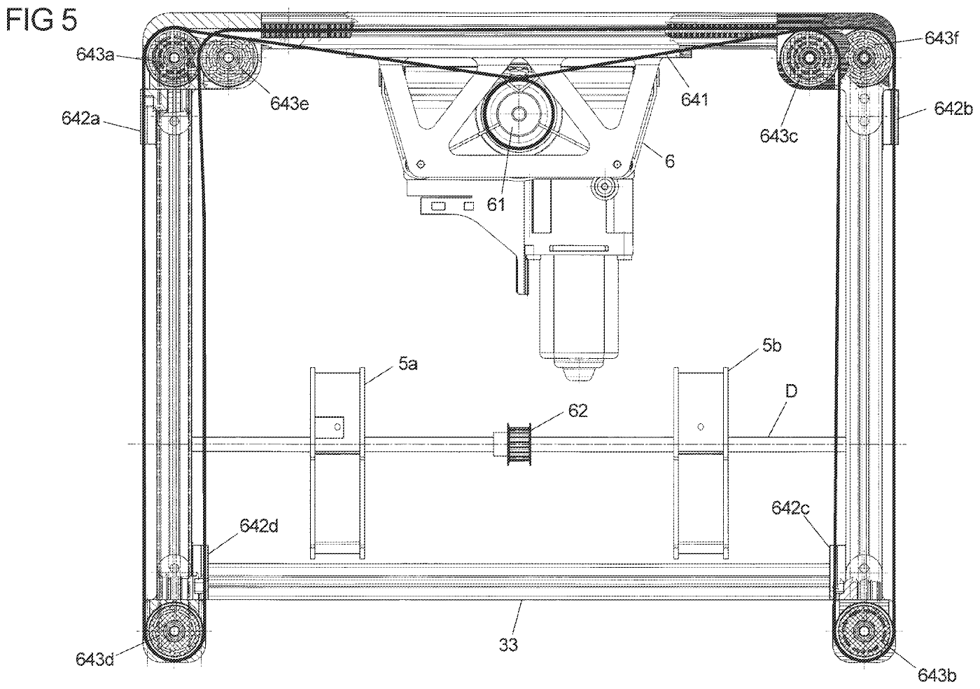

Proceeding from the drive 6, the second traction means 641 is extended in the direction of the ends of the arms 4a, 4b, 4c, 4d arranged on the second lateral part 3. The second traction means 641 forms a closed loop which, proceeding from the drive 6, is extended along the first pair of ends of the arms 4a, 4b, 4c, 4d to the second pair of ends of the arms 4a, 4b, 4c, 4d on the other side of the second lateral part 2, 3 and back to the drive 6, as is shown in FIG. 5.

The second traction means 641 each is extended in opposite directions proceeding from the drive 6 to a first driver 642a, 642c via a first deflection element 643a, 643c. The two first drivers 642a, 642c act in opposite directions. One of the first drivers 642a is arranged on a side of the second lateral part 3 facing away from the storage space 1. The other one of the first drivers 642c is arranged on a side of the second lateral part 3 facing the storage space 1. The second traction means 642 each is extended from the first drivers 642a, 642c over a second deflection element 643b, 643d to the second drivers 642b, 642d. The second drivers 642b, 642d also act in opposite directions. On the respective side of the second lateral part 3, the respective first and second drivers 642a, 642b, 642c, 642d also act in opposite directions. An adjustment of the second traction means 641 in one direction hence effects an oppositely directed movement of the first and second drivers 642a, 642b, 642c, 642d on each side of the second lateral part 3. The second traction means 641 each is extended from the second drivers 642b, 642d over a third deflection element 643e, 643f past the drive 6 to the respectively opposite third deflection element 643e, 643f in order to close the loop.

The drive 6 is also configured to rotate the winding elements 5a, 5b. By means of the drive 6, the two first traction means 51a, 51b hence can be wound up on and unwound from the winding elements 5a, 5b. Thus, a length of the base surface 10 and the distance L between the two lateral parts 2, 3 are adjustable by the common drive 6 synchronously with each other. In principle, an adjustment of the two lateral parts 2, 3 relative to each other requires an adjustment of the base surface 10. Due to the synchronous adjustment of the base surface 10 with the distance L, the length of the base surface 10 is reduced when the distance L between the two lateral parts 2, 3 is reduced, and the length of the base surface 10 is increased when the distance L between the two lateral parts 2, 3 is increased.

For transmitting a driving force from the drive 6 to the two winding elements 5a, 5b a transmission mechanism is provided, which connects the drive 6 with the two winding elements 5a, 5b. Via the transmission mechanism, the driving force of the drive 6 is transmitted to the winding elements 5a, 5b. The transmission mechanism can be configured to convert a constant driving force into a positively or negatively accelerated movement of the winding elements 5a, 5b. For example, the transmission mechanism can be configured to convert a driving force that generates a constant velocity into an accelerated movement. For this purpose, the transmission mechanism can comprise a spur-gear transmission. As an example, the spur-gear transmission can be of the eccentric type and/or have lever arms of different length. By means of an eccentric spur-gear transmission, a rotation with a constant angular velocity can be converted into a rotation with a positively or negatively accelerated angular velocity.

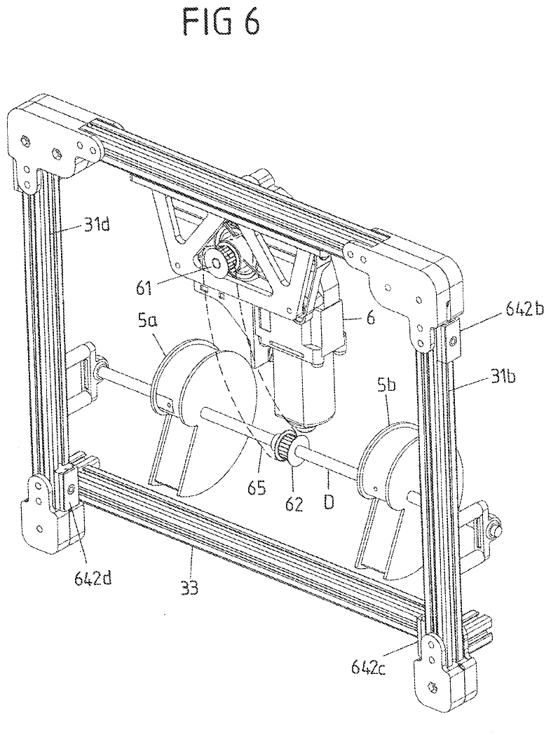

In the exemplary embodiment shown in FIG. 6, the transmission mechanism comprises a third flexible traction means 65. The third traction means 65 can be driven by means of an input-side pinion 61. On an axis of rotation D of the winding elements 5a, 5b, via which the winding elements 5a, 5b are rotatable, a further pinion 62 is provided. The pinion 62 provided on the axis of rotation is engaged by the drive 6 by means of third traction means 65 on the axis of rotation D of the winding elements 5a, 5b. An adjusting movement of the third traction means 65, which is caused by the drive 6, thereby is converted into a rotation of the winding elements 5a, 5b. The drive 6 hence rotates the axis of rotation D by means of the third traction means 65.

By winding up the first traction means 51a, 51b on the associated winding elements 5a, 5b, a length of the base surface 10 can be adapted to the distance L of the two lateral parts 2, 3. For the adjustment from the maximum position into the stowage position and vice versa, the winding elements 5a, 5b are rotated about the axis of rotation D almost once. The rotation between the maximum position shown in FIG. 2A and the stowage position shown in FIG. 2B amounts to 340°. In a constant angular interval 521, 522 a length of a portion of the first traction means 51a, which is wound up on the winding element 5a, depends on the direction of the angular interval 521, 522 relative to a point on the winding element 5a. The direction here is understood to be radial and perpendicular to an axis, such as the axis of rotation D, through the point.

By way of example, FIG. 2B shows two angular intervals 521, 522 which are arranged in different directions relative to the axis of rotation D. The angular intervals 521, 522 each sweep over an angle of 90°. The alignment of the angular intervals 521, 522 to each other is shifted relative to the axis of rotation D by 90°. The first angular interval 521 for example sweeps over a range of 90-180°. The second angular interval 522 sweeps over a range of 0-90°. The length of the portion of the first traction means 51a wound up on the winding element 5a, which is arranged within the first angular interval 521, is longer than the length of the portion of the first traction means 51a wound up on the winding element 5a, which is arranged within the second angular interval 522.

A radius R of the winding element 5a hence varies in dependence on the observed angular interval 521, 522 relative to the axis of rotation D. The radius R here is understood to be a distance that is extended between the axis of rotation D and the edge of the winding element 5a on which the first traction means 51 is wound up. The radius R of the winding elements 5a, 5b, 5c hence is designed to complete the accelerated adjustment of the first lateral part 2 by an accelerated unwinding or winding up of the first traction means 51a, 51b. It thereby is ensured that the first traction means 51a, 51b between the two lateral parts 2, 3 are stretched perpendicularly to the lateral parts independently of the position of the lateral parts 2, 3.

The radius R is a function of the azimuth angle from the axis of rotation D. For example, the radius R is greater in the first angular interval 521 than in the second angular interval 522. Furthermore, the radius R is a function of the distance Lₘₐₓ between the two lateral parts 2, 3 in the maximum position.

FIG. 3A shows a perspective of the device from the direction of the second lateral part 3. For fixing the first traction means 51a, 51b, the winding elements 5a, 5b each comprise a fastening element 50a, 50b. The two winding elements 5a, 5b are rotatably mounted on the second lateral part 3 by means of an axis of rotation D. The axis of rotation D is rotatably arranged on the second lateral part 3. For rotating the axis of rotation D, a pinion 62 is provided on the axis of rotation D, on which the axis of rotation D is rotatable by means of a third traction means 65. The drive 6 engages the axis of rotation D via the third traction means 65. The pinion 62 is arranged centrally on the axis of rotation D between the two winding elements 5a, 5b. The winding elements 5a, 5b each are arranged at the inner edge of the outer quarters of the axis of rotation D. The pinion 62 is arranged centrally between the winding elements 5a, 5b.

In the maximum position shown in FIG. 3A, the arms 4a, 4b, 4c, 4d each form rectangles with the sides of the lateral parts 2, 3 on both sides of the base surface 10, which rectangles laterally delimit the storage space 1. In the stowage position shown in FIG. 3B, the volume of the storage space 1 is minimal. The two lateral parts 2, 3 rest against each other.

In the embodiment shown in FIG. 4, the device comprises three winding elements 5a, 5b, 5c, on each of which a first traction means 51a, 51b, 51c can be wound. The storage space 1 is additionally delimited by a net 11.

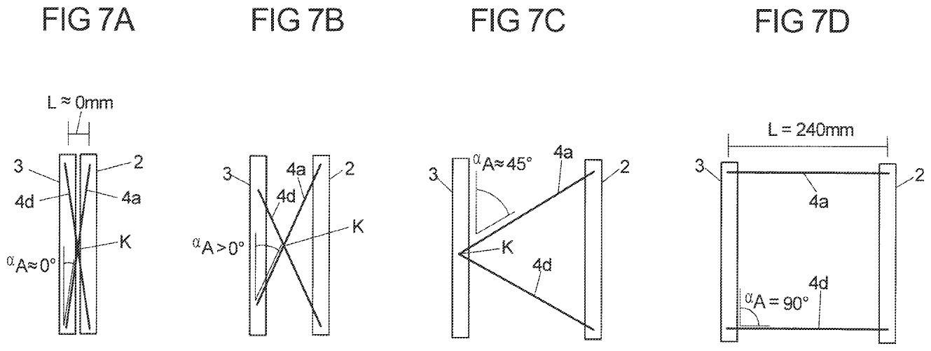

FIGS. 7A to 7D show an adjustment of the two lateral parts 2, 3 relative to each other from the stowage position into the maximum position. The lateral parts 2, 3 here move away from each other, whereby the storage space 1 is increased.

In the stowage position shown in FIG. 7A, the distance L between the two lateral parts 2, 3 is minimal. In the illustrated embodiment, the distance L between the lateral parts 2, 3 in the stowage position is 0 mm. In principle, the distance between the lateral parts 2, 3 in the stowage position can be chosen arbitrarily. The pair of arms 4a, 4d shown on the side of the lateral parts 2, 3 facing the viewer is crossed at a crossing point K. In the stowage position, the crossing point K is arranged in the middle between the two lateral parts 2, 3. The distances between the ends of the arms 4a, 4d at the two lateral parts 2, 3 are the same. On the other side of the lateral parts 2, 3 another pair of arms 4b, 4c can be arranged, which likewise is crossed. The arm angle as of each of the arms 4a, 4d relative to the second lateral part 2, 3 is approximately 0°. The arms 4a, 4d hence are approximately parallel to the lateral parts 2, 3. In principle, the adjustment of the lateral parts 2, 3 can be effected by means of one or more than two pairs of arms 4a, 4b, 4c, 4d. In an alternative embodiment, there is provided an arm by means of which the lateral parts 2, 3 are adjustable relative to each other.

In FIG. 7B, the distance of the ends of the arms 4a, 4d that are arranged on the second lateral part 3 is smaller than the distance of the ends of the arms 4a, 4d that are arranged on the first lateral part 2. Compared to the maximum position, the ends of the arms 4a, 4d that are arranged on the second lateral part 3 have been shifted towards each other. The arm angle as of each of the arms 4a, 4d relative to the second lateral part 3 is greater than 0°. The first lateral part 2 is spaced apart relative to the second lateral part 3 due to the displacement of the ends of the arms 4a, 4d along the second lateral part 3. The displacement of the ends of the arms 4a, 4d along the second lateral part 2, 3 hence is convertible into an adjusting force on the first lateral part 2. The crossing point K is arranged between the lateral parts 2, 3. Due to the displacement of the ends of the arms 4a, 4d towards each other, the crossing point K is spaced closer to the second lateral part 3 than to the first lateral part 2.

In FIG. 7C, the arm angle as of each of the arms 4a, 4d relative to the second lateral part 3 amounts to 45°. In this position, the crossing point K coincides with the ends of the arms 4a, 4d that are arranged on the second lateral part 3.

In the maximum position shown in FIG. 7D, in which the one arm 4a is arranged at the upper end of the second lateral part 3, which is spaced from the base surface 10, and the other arm 4b is arranged at the lower end of the second lateral part 3 to which base surface 10 adjoins, the arms 4a, 4d are arranged in parallel. The arm angle as of the arms 4a, 4d relative to the lateral parts 2, 3 amounts to 90° in the maximum position. In the illustrated embodiment, the distance L between the lateral parts 2, 3 is 240 mm in the maximum position. In principle, the distance between the lateral parts 2, 3 can be any size in the maximum position.

A movement of the ends of the arms 4a, 4b, 4c, 4d, which are shiftably mounted on the second lateral part 3, at a constant speed, can be converted into a movement of the first lateral part 2, 3, wherein the speed of the movement depends on the distance L of the lateral parts 2, 3 or the arm angle as of the arms 4a, 4b, 4c, 4d to the lateral parts 2, 3, hence is non-uniform. An adjustment of the first traction means 51a, 51b, 51c hence must also be effected at a speed that depends on the distance L between the lateral parts 2, 3. The winding elements 5a, 5b, 5c are configured to provide a non-uniform speed when the first traction means 51a, 51b, 51c are wound up or unwound. Moreover, the radii of the winding elements 5a, 5b, 5c are dependent on the azimuth angle α_{w} with respect to the axis of rotation D.

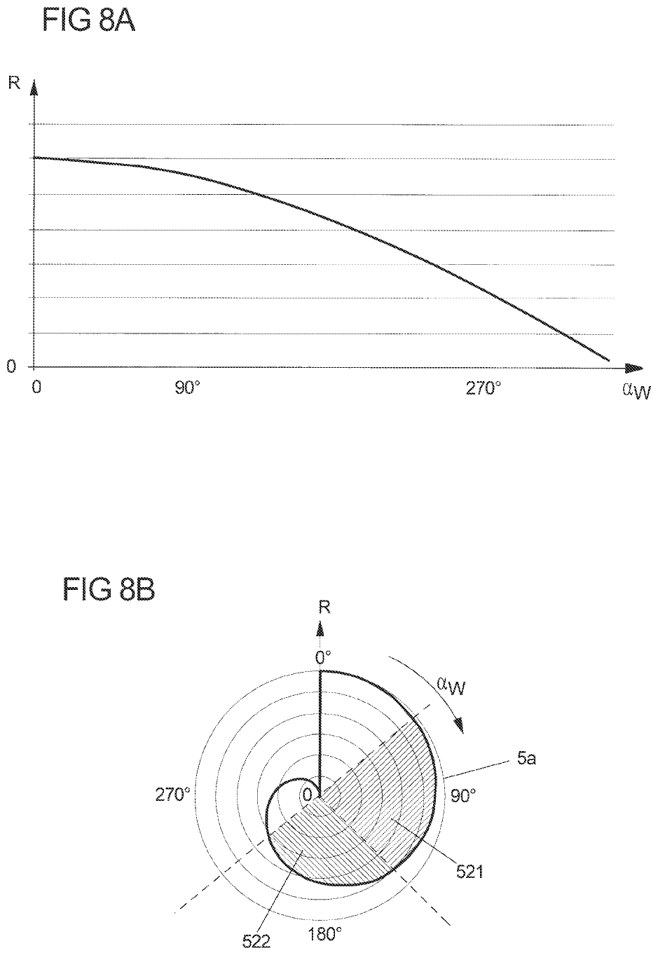

A suitable function for the radius R in dependence on the azimuth angle α_{w} with respect to the axis of rotation D is shown in FIG. 8A. At an azimuth angle α_{w} of 0°, the radius R is greater than at any azimuth angle α_{w} greater than 0° and less than 360°. For example, unrolling from the winding element 5a by an angular interval of 0-10° provides a larger portion of the first traction means 51a than unrolling from the winding element 5a by an angular interval of 10-20°. The length of the portion of the first traction means 51a unrolled or rolled up hence depends on the position of the angular interval unrolled or rolled up on the winding element 5a.

The connection between the radius R of the winding element 5a and the azimuth angle α_{w} with respect to the axis of rotation D can be illustrated in a radial representation, as shown in FIG. 8B. In the adjoining area between 359° and 0°, the function is not continuous. At this point, a jump of the radius R from almost zero to the maximum radius is obtained. In principle, the radius R of the winding element 5a can be a continuous function and/or periodic function of the azimuth angle α_{w}.

A first angular interval 521 is indicated in a range between 45° and 135°. A second angular interval 522 is indicated in a range between 135° and 225°. The first angular interval 521 comprises larger radii than the second angular interval 522. On an area of the winding element 5a that lies in the first angular interval 521 a longer portion of the first traction means 51a hence can be wound or be unwound than on an area of the winding element 5a that lies in the second angular interval 522.

At a constant rotational speed of the winding element 5a, differently long portions of the first traction means 51a are unwound in dependence on the position of the unwound angular interval 521, 522 on the winding element 5a. This ensures that the length of the base surface 10 and the distance L between the two lateral parts 2, 3 are adjustable synchronously with each other.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.
1 storage space
10 base surface
11 net
2, 3 lateral part
21a, 21b joint
22a, 22b, 32a, 32b frame element
24, 34 side wall
31a, 31b, 31c, 31d guide
33 guide element
4a, 4b, 4c, 4d arms
5a, 5b, 5c winding element
50a, 50b fastening element
51a, 51b, 51c first traction means
521, 522, Δα angular interval
6 drive
61, 62 pinion
64 Bowden cable
641 second traction means
642a, 642b, 642c, 642d driver
643a, 643b, 643c, 643d, 643e, 643f deflection element
65 third traction means
7a, 7b wheel
C constant
D axis of rotation
F vehicle seat
K crossing point
L distance
Lₘₐₓ distance in the maximum position
R radius
α_{A} arm angle
α_{w} azimuth angle

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A storage device configured to form a storage space for use in a motor vehicle, the storage device comprising:
a base surface forming a portion of the storage space;
opposing lateral parts spaced apart by a distance configured to vary a volume of the storage space; and
a first flexible traction means forming a portion of the base surface.

2. The storage device of claim 1, wherein the first flexible traction means stretches between and is perpendicular to the opposing lateral parts.

3. The storage device of claim 2, further comprising:
a winding element, wherein the first flexible traction means includes a first end and a second end opposite thereto, the first end fixed to a first lateral part of the opposing lateral parts and the second end fixed to the winding element, wherein the winding element is configured to wind up the first flexible traction means.

4. The storage device of claim 3, further comprising:
a guide element disposed on a second lateral part of the opposing lateral parts wherein the first flexible traction means extends over the guide element to the winding element.

5. The storage device of claim 3, wherein a portion of the first flexible traction means is configured to be wound up on the winding element and the first portion has a first length configured to vary periodically with respect to an angular interval based on a direction of an angular interval extending from a point on the winding element.

6. The storage device of claim 5, wherein a radius R extends from the point to an edge of the winding element and the radius R is based on an angle extending from the point, wherein,
$$R ( {α}_{W} ) = {L}_{max} \times \frac{sin ( C ( {α}_{W} + {Δα}_{W} ) ) - sin ( C \times {α}_{W} )}{{Δα}_{W}}$$
Lₘₐₓ is a distance between the opposing lateral parts disposed in a maximum position of the device, in which the volume of the storage space is maximal,
Δα_{w} is the angular interval, and
C is a constant value.

7. The storage device of claim 3, wherein the winding element is configured to perform at least one rotation about an axis of rotation to wind up or unwinding the first flexible traction means.

8. The storage device of claim 1, further comprising:
a first lever arm connecting the opposing lateral parts to each other and configured to adjust to vary a distance between the opposing lateral parts.

9. The storage device of claim 8, wherein the first lever arm is arranged on sides of the opposing lateral parts adjacent to the base surface.

10. The storage device of claim 8, further comprising:
a second lever arm wherein when a volume of the storage space is maximal, the first and second lever arms extend parallel to each other, and when the volume of the storage space is minimal, the first and second lever arms are crossed.

11. The storage device of claim 10, wherein the first and second lever arms are disposed on the opposing lateral parts and are arranged symmetrically with respect to the base surface and face one another.

12. The storage device of any of claim 8, wherein the first lever arm includes a first end, configured to pivotally articulate with respect to the first lateral part, and a second end mounted to and configured to shift with respect to the second lateral part.

13. The storage device of claim 12, further comprising:
a driver coupled to the second end of the lever arm;
a first guide disposed on the second lateral part; and
a Bowden cable configured to shift the driver along the first guide.

14. The storage device of claim 13, further comprising:
a frame element including a first side and a second side opposing the first side, wherein the frame element laterally delimits the second lateral part in a direction perpendicular to the base surface; and
a second guide, wherein the first guide is disposed on the first side of the frame element and the second guide is disposed on the second side of the frame element, wherein the first lever arm extends from the first guide to the second lateral part.

15. The storage device of claim 1, further comprising:
a common drive configured to adjust the opposing lateral parts and the base surface so that a length of the base surface and the distance between the opposing lateral parts are synchronously adjusted with one another.

16. The storage device of claim 15, further comprising:
transmission mechanism; and
a winding element operatively connected to the common drive by the transmission mechanism and configured to wind the first flexible traction means to move a first lateral part of the opposing lateral parts.

17. The storage device of claim 16, wherein the transmission mechanism includes a second flexible traction means and/or a number of spur gears.

18. The storage device of claim 13, further comprising:
a drive configured to rotate the winding element and actuate the Bowden cable at the same time.

19. (canceled)

20. A storage device configured to form a storage space for use in a motor vehicle, the storage device comprising:
a number of belts configured to move from an extended position, to form a base surface of the storage space, and a retracted position;
a first lateral wall and a second lateral wall opposing the first lateral wall configured to be spaced apart from one another when the number of belts are in the extended position; and
a winding element having a snail cam shape configured to wind up and move the number of belts between the extended position and the retracted position.

21. The storage device of claim 20, further comprising:
a drive; and
a number of spur gears operatively coupled the drive and the winding element configured to transmit a drive force from the drive to rotate the winding element.
